(19) United States
(12) Patent Application Publication
(10) Pub. No.: US 2025/0045499 A1
(43) Pub. Date: Feb. 6, 2025

(54) MACHINE LEARNING-BASED METHODS, DEVICES, AND COMPUTER-READABLE STORAGE MEDIA FOR MEASURING BENDING STIFFNESS OF FABRICS

(71) Applicant: ZHEJIANG LINGDI DIGITAL TECHNOLOGY CO., LTD., Hangzhou (CN)

(72) Inventors: Chen LIU, Hangzhou (CN); Huamin WANG, Hangzhou (CN)

(73) Assignee: ZHEJIANG LINGDI DIGITAL TECHNOLOGY CO., LTD., Hangzhou (CN)

(21) Appl. No.: 18/920,973

(22) Filed: Oct. 20, 2024

Related U.S. Application Data
(63) Continuation of application No. PCT/CN2022/090955, filed on May 5, 2022.

(51) Int. Cl. G06F 30/27; G06F 113/12

(52) U.S. Cl. CPC G06F 30/27; G06F 2113/12

(57) ABSTRACT

The present disclosure provides a machine learning-based method for measuring bending stiffness of a fabric, comprising: obtaining an image of a fabric to be tested placed on a three-dimensional geometric object; and determining the bending stiffness of the fabric to be tested by inputting the image of the fabric to be tested into a trained deep neural network.

### CROSS-REFERENCE TO RELATED APPLICATIONS

This application is a continuation of international application No. PCT/CN2022/090955, filed on May 5, 2022, the contents of which are hereby incorporated by reference.

### TECHNICAL FIELD

The present disclosure relates to the technical field of drape morphology simulation of fabric samples, and in particular, to machine learning-based methods, devices, and computer-readable storage media for measuring the bending stiffness of a fabric.

### BACKGROUND

As is well known, bending stiffness is important for all fabrics, but it is extremely difficult to measure and simulate accurately. Performance and accuracy are two important indicators for measuring a simulation engine of a physical fabric. Although great success has been achieved in simulation performance of the simulation engine in recent years, progress in the accuracy of simulation of the simulation engine has been very limited. This situation is particularly harsh for designers and developers of digital fashion, as they require more accurate simulation to create virtual clothing similar to real samples.

Among the factors that affect the accuracy of simulation, the planar stiffness and the bending stiffness may be the two most critical factors. Planar stiffness is usually only important for elastic fabrics because it exhibits strong stretchability in the production of underwear or sportswear. Bending stiffness is almost important for all fabrics because it determines the softness of the fabric and the details of the wrinkles. Due to the nonlinearity, anisotropy, and diversity of bending stiffness in the real world, its accurate measurement has become a huge challenge.

Therefore, it is desirable to provide a method for accurately measuring the stiffness of fabrics.

### SUMMARY

A first aspect of the present disclosure provides a machine learning-based method for measuring bending stiffness of a fabric, comprising: obtaining an image of a fabric to be tested placed on a three-dimensional geometric object; and determining the bending stiffness of the fabric to be tested by inputting the image of the fabric to be tested into a trained deep neural network.

In some embodiments, the trained deep neural network is trained using training data, the training data being obtained by a process including: obtaining sample images of a plurality of sample fabrics placed on a sample three-dimensional geometric object; obtaining nonlinear bending moduli and/or anisotropic bending moduli of the plurality of sample fabric; constructing a parameter dataset based on the nonlinear bending moduli and the anisotropic bending moduli of the plurality of sample fabrics; constructing an autoencoder subspace model using the parameter dataset, generating a simulated dataset by obtaining an initial state of each parameter vector in the autoencoder subspace model, and generating a multi-view depth image corresponding to each sample image of each sample fabric based on the simulated dataset; and determining multi-view depth images corresponding to the sample images of the plurality of sample fabrics as the training data.

In some embodiments, the obtaining the nonlinear bending moduli and the anisotropic bending moduli of the plurality of sample fabrics includes: for each of the plurality of sample fabrics, preparing a fabric strip of the sample fabric; obtaining an image of the fabric strip when the fabric strip is placed on a cantilever tester; obtaining a curve sample point set based on the image of the fabric strip, the curve sample point set including multiple curve sample points; determining a torque of each curve sample point in the curve sample point set; and determining the nonlinear bending moduli and the anisotropic bending moduli of the sample fabric based on the torque of each curve sample point.

In some embodiments, the obtaining a curve sample point set based on the image of the fabric strip and determining a torque of each curve sample point in the curve sample point set includes: fitting a bending curve of the fabric strip based on at least one control point selected from the image of the fabric strip, determining the curve sample point set by sampling the bending curve of the fabric strip uniformly along an X-axis, the curve sample point set including curve sample points {r₀, . . . , r_{N}}; determining a magnitude of the torque at a curve sample point rᵢ according to following formula:

$${τ}_{i} = E ‖ {\int }_{{s}_{i}}^{{s}_{N}} ( r ( s ) - {r}_{i} ) \times d f ( s ) ‖ = ρ gE {\int }_{{s}_{i}}^{{s}_{N}} ( x ( s ) - {x}_{i} ) d s ,$$

where τᵢ denotes the magnitude of the torque at a curve sample point rᵢ, τ denotes a density of the sample fabric, g denotes a gravitational acceleration, E denotes a width of the fabric strip, s denotes an arc length, and sᵢ and s_{N} denote arc lengths of the curve sample points τᵢ and r_{N}, respectively, df(s) denotes a differential component of a force at a corresponding position when the arc length is s, x(s) denotes a projection of the corresponding position when the arc length is s on the X-axis, and xᵢ denotes a projection of the i-th curve sample point on the X-axis.

In some embodiments, the determining the nonlinear bending moduli and the anisotropic bending moduli of the sample fabric based on the torque of each curve sample point includes: determining six parameters that is obtained by defining two bending moduli of the sample fabric in a warp direction, a weft direction, and an oblique yarn direction, respectively, as the nonlinear bending moduli of the sample fabric; calculating a principal curvature and a direction of the principal curvature on each vertex of each dihedral angle element formed based on the image of the sample fabric; and determining the anisotropic bending moduli of the sample fabric by estimating an average of directions of maximum principal curvatures of two edge points of a connected edge of the dihedral angle element as a bending direction of the dihedral angle element.

In some embodiments, the constructing the autoencoder subspace model using the parameter dataset includes: randomly selecting a portion of parameter vectors in the parameter dataset as a training set and the other portion of parameter vectors in the parameter dataset as an evaluation set; training the autoencoder subspace model using an Adam optimizer to obtain a trained autoencoder subspace model; and evaluating the trained autoencoder subspace model using the evaluation set.

In some embodiments, before constructing the autoencoder subspace model using the parameter dataset, the method further includes: increasing the parameter vectors in the parameter dataset by: using a Gaussian distribution N(μ, σ) to sample parameters in the parameter dataset, wherein μ∈ [−0.5, 0.5] and σ∈ [0.8, 1.2] and μ and σ are two uniformly distributed random variables.

In some embodiments, the generating a simulated dataset by obtaining an initial state of each parameter vector in the autoencoder subspace model includes: for each parameter vector in the autoencoder subspace model, randomly generating multiple initial states of the sample fabric; adding a random perturbation to a position of each initial state of the sample fabric; obtaining an initial state parameter vector by simulating the random perturbation of the sample fabric until the sample fabric is static; and adding the initial state parameter vector and the corresponding parameter vector into the simulated dataset.

In some embodiments, the initial state includes: a state formed by adding a random sine wave to fabric meshes of the sample fabric in flat; a state formed by intentionally folding fabric meshes of the sample fabrics in a randomly selected direction; or a state determined by randomly selecting an initial state of a sample fabric that have been simulated in the simulated dataset.

In some embodiments, the generating a multi-view depth image corresponding to each sample image of each sample fabric based on the simulated dataset includes: obtaining at least one random orientation of each simulated data in the simulated dataset by performing stratified random sampling; and synthesizing at least one set of multi-view depth image by randomly perturbing, using the at least one random orientation, a position, pose, or field of view of a camera.

In some embodiments, the trained deep neural network is trained by: defining a loss function of a deep neural network as a root mean square error L between a ground truth {gᵢ} and an estimated result {pᵢ}, wherein

$$L = {( \frac{{\sum }_{i = 1}^{N} {‖ {p}_{i} - {g}_{i} ‖}^{2}}{N} )}^{1 / 2}$$

where N denotes a batch size, and training the deep neural network using an Adam optimizer to obtain the trained deep neural network.

A second aspect of the present disclosure provides a system, comprising: at least one storage device storing executable instructions for measuring bending stiffness of a fabric; and at least one processor in communication with the at least one storage device, wherein when executing the executable instructions, the at least one processor is configured to cause the system to perform operations including: obtaining an image of a fabric to be tested placed on a three-dimensional geometric object; and determining the bending stiffness of the fabric to be tested by inputting the image of the fabric to be tested into a trained deep neural network.

A third aspect of the present disclosure provides a non-transitory computer readable medium, comprising at least one set of instructions for measuring bending stiffness of a fabric, wherein when executed by at least one processor of a computing device, the at least one set of instructions direct the at least one processor to perform operations including: obtaining an image of a fabric to be tested placed on a three-dimensional geometric object; and determining the bending stiffness of the fabric to be tested by inputting the image of the fabric to be tested into a trained deep neural network.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

FIG. 1 is a schematic diagram illustrating an exemplary principle for measuring the bending stiffness of a fabric based on a cantilever manner according to some embodiments of the present disclosure;

FIG. 2 is a diagram illustrating a bending state of a fabric strip according to some embodiments of the present disclosure;

FIG. 3A is a flowchart illustrating an exemplary process 300A for determining a bending stiffness of a fabric according to some embodiments of the present disclosure;

FIG. 3B is a flowchart illustrating an exemplary process 300B for training a deep neural network for determining a bending stiffness of a fabric according to some embodiments of the present disclosure;

FIG. 4 is a schematic diagram illustrating a stretched state of a fabric according to some embodiments of the present disclosure;

FIG. 5 is a schematic diagram illustrating bending along connected edges of a dihedral angle element in a dihedral angle model according to some embodiments of the present disclosure;

FIG. 6 is a schematic diagram illustrating an exemplary bending stiffness measurement device according to some embodiments of the present disclosure;

FIG. 7 is a schematic diagram illustrating a bending curve of a fabric strip according to some embodiments of the present disclosure;

FIG. 8 is a schematic diagram illustrating a state of a fabric formed by adding a random sine wave to meshes of the fabric when the fabric is in a flat state according to some embodiments of the present disclosure;

FIG. 9 is a schematic diagram illustrating a state of a fabric formed by intentionally folding fabric meshes in a randomly selected direction according to some embodiments of the present disclosure;

FIG. 10A is a diagram illustrating an exemplary depth image of the front side according to some embodiments of the present disclosure;

FIG. 10B is a diagram illustrating an exemplary depth image of the left side according to some embodiments of the present disclosure;

FIG. 10C is a diagram illustrating an exemplary depth image of the back side according to some embodiments of the present disclosure;

FIG. 10D is a diagram illustrating an exemplary depth image of the right side according to some embodiments of the present disclosure;

FIG. 11 is a schematic diagram illustrating an exemplary structure of a deep neural network according to some embodiments of the present disclosure;

FIG. 12 is a schematic diagram illustrating an exemplary bending stiffness measurement system according to some embodiments of the present disclosure; and

FIG. 13 is a schematic diagram illustrating exemplary hardware and/or software components of an exemplary computing device according to some embodiments of the present disclosure.

### DETAILED DESCRIPTION

The following description is presented to enable any person skilled in the art to make and use the present disclosure and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown but is to be accorded the widest scope consistent with the claims.

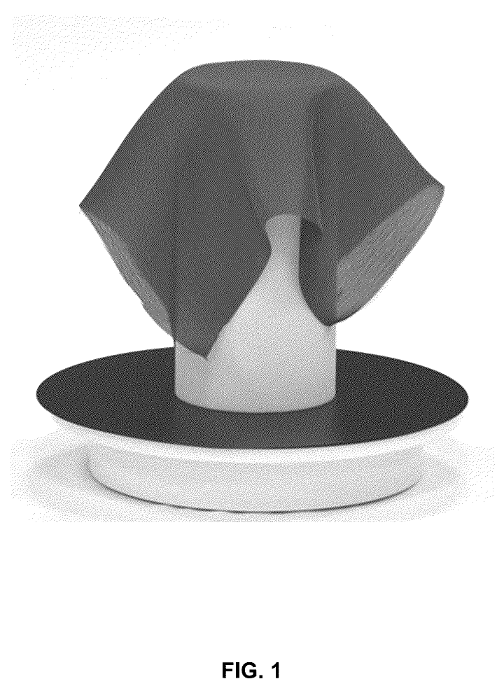

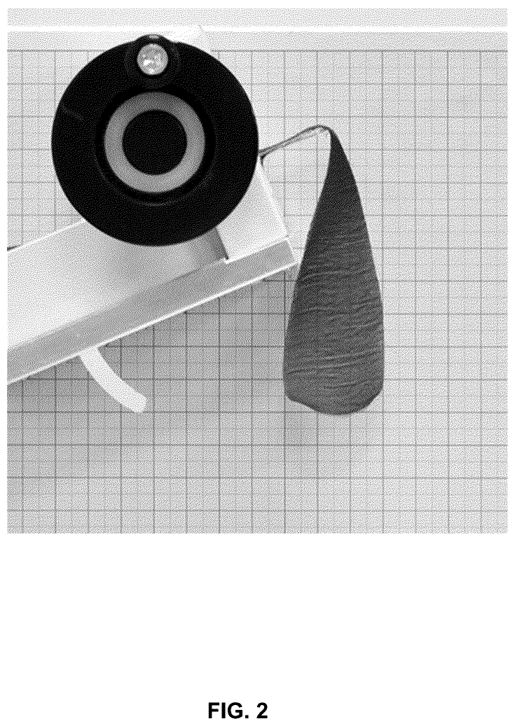

Over the past few decades, fabric engineers have developed a variety of standardized tests related to bending stiffness, including the cantilever test, the heart loop test, and the drape test. The cantilever test is probably the most common and intuitive when compared to other methods. FIG. 1 is a schematic diagram illustrating an exemplary principle for measuring the bending stiffness of a fabric based on a cantilever manner according to some embodiments of the present disclosure. Assuming that there is no correlation between bending properties of the fabric in each direction, the cantilever test is a method that utilizes an overhead cantilever to test how much a fabric strip can bend under its weight, as illustrated in FIG. 1. In the field of graphics, the cantilever test also seems to be the standard for obtaining bending stiffness of the fabric. FIG. 2 is a diagram illustrating a bending state of a fabric strip according to some embodiments of the present disclosure.

However, when using the cantilever test, even experienced users need to take a long time (which includes the time to prepare the fabric strip sample and the actual measurement time) (e.g., 15 minutes) to measure the bending stiffness of a single fabric. Therefore, a significant cost in time is required if thousands of fabrics need to be measured. Moreover, many fabric strips may exhibit a bending effect as shown in FIG. 2, making accurate measurements using the cantilever test a difficult problem.

Embodiments of the present disclosure provide a machine learning-based method for measuring bending stiffness of a fabric. The method comprises obtaining an image of a fabric to be tested placed on a three-dimensional geometric object; and determining the bending stiffness of the fabric to be tested by inputting the image of the fabric to be tested into a trained deep neural network. The trained deep neural network is trained using training data. The training data is obtained by a process including: obtaining sample images of a plurality of sample fabrics placed on a sample three-dimensional geometric object; obtaining nonlinear bending moduli and anisotropic bending moduli of the plurality of sample fabric; constructing a parameter dataset based on the nonlinear bending moduli and the anisotropic bending moduli of the plurality of sample fabrics; constructing an autoencoder subspace model (e.g., a variational autoencoder (VAE) subspace model) using the parameter dataset, generating a simulated dataset by obtaining an initial state of each parameter vector in the autoencoder subspace model, and generating a multi-view depth image corresponding to each sample image of each sample fabric based on the simulated dataset; and determining multi-view depth images corresponding to the sample images of the plurality of sample fabrics as the training data.

Accordingly, through the method provided in the present disclosure, there is no need to use the cantilever test to measure data of each fabric, which saves a lot of time; at the same time, after simulating the initial state of each parameter vector in the autoencoder subspace model, a real state of the fabric is simulated as much as possible, which improves the accuracy of measurement.

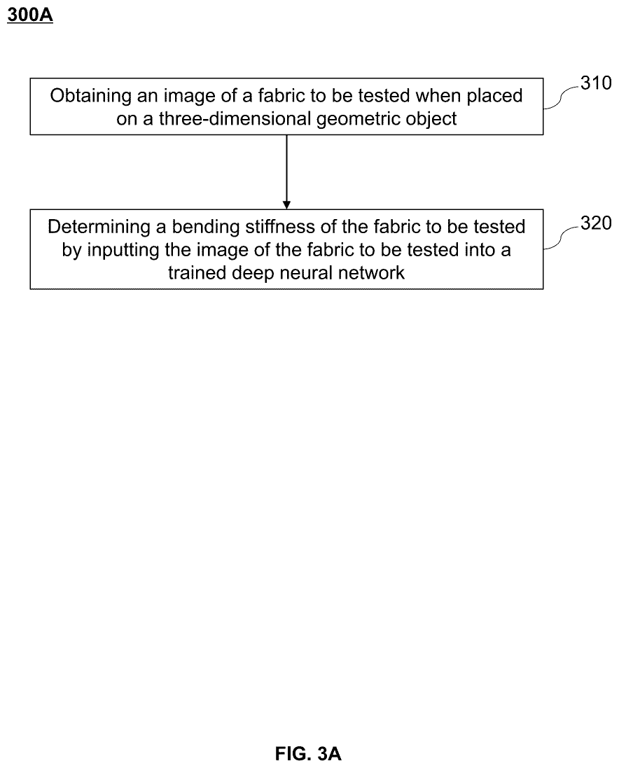

FIG. 3A is a flowchart illustrating an exemplary process 300A for determining a bending stiffness of a fabric according to some embodiments of the present disclosure. In some embodiments, process 300A may be executed by a processing device (e.g., the processing device 1212). For example, process 300A may be implemented as a set of instructions (e.g., an application) stored in a storage medium, and the following bending stiffness measurement device may execute the set of instructions and may accordingly be directed to perform process 300A.

In 310, an image of a fabric to be tested when placed on a three-dimensional geometric object may be obtained. In some embodiments, the three-dimensional geometric object may be any object that can support the fabric to be tested, such as a cylinder, a cube, a sphere, a human model, etc. At least a portion of the fabric to be tested is placed on the three-dimensional geometric object and supported by the three-dimensional geometric object, while the remaining portion of the fabric to be tested sags without being supported by the three-dimensional geometric object.

In some embodiments, the image may be captured by an image acquisition device (e.g., the image acquisition device 1230). In some embodiments, the image may be directly obtained from a storage device (e.g., the storage device 1250).

In 320, a bending stiffness of the fabric to be tested may be determined by inputting the image of the fabric to be tested into a trained deep neural network. The deep neural network may be trained according to a process described in FIG. 3B.

In some embodiments, the trained deep neural network may include a convolutional neural network (CNN), a fully convolutional neural network (FCN) (e.g., a U-Net, a V-Net), a recurrent neural network (RNN), a region CNN (RCNN), a fast-RCNN, a generative adversarial network (GAN) (e.g., a pix2pix network, a Wasserstein GAN (WGAN) network), or the like, or any combination thereof. The image of the tested fabric placed on the three-dimensional geometric object may be input into the trained deep neural network, and the trained deep neural network may output the bending stiffness of the fabric to be tested.

FIG. 3B is a flowchart illustrating an exemplary process 300B for training a deep neural network for determining a bending stiffness of a fabric according to some embodiments of the present disclosure. The training of the deep neural networks may be performed by a training device. The training device may be the same as or different from a device used to measuring bending stiffness of the fabric to be tested. For example, the training device may be a device or system of a vendor of a manufacturer who provide and/or maintain such deep neural networks.

The training device may first obtain training data and then use the obtained training data to train a deep neural network. The training data may include an image of a sample fabric placed on a three-dimensional geometric object (abbreviated as a sample fabric image). When using images as training data, uncontrollable external factors such as shooting angle, lens properties, lighting, fabric color, etc., may cause excessive diversity of training data, thereby increasing the difficulty the training of the deep neural network. Therefore, based on the sample fabric images, a state of the sample fabrics can be simulated (or modeled) to generate multi-view depth images corresponding to the sample fabric images. Then, using the multi-view depth images, the deep neural network may be trained to obtain the trained deep neural network. The specific operations for determining the trained deep neural network are as follows.

In 311, an image of a sample fabric when placed on a three-dimensional geometric object may be obtained, and one or more nonlinear bending moduli and/or anisotropic bending moduli of the sample fabric may also be obtained. A parameter dataset may be constructed based on the nonlinear bending moduli and/or the anisotropic bending moduli of a plurality of sample fabrics. For each sample fabric, the parameter dataset may include a relationship among the sample fabric image, the one or more nonlinear bending moduli, and the anisotropic bending moduli of the sample fabric.

In 312, a processed parameter dataset may be obtained by normalizing parameters in the parameter dataset. It should be noted that in some embodiments, operation 312 may be omitted.

In 313, an autoencoder subspace model (e.g., a variational autoencoder (VAE) subspace model) may be constructed using the processed parameter dataset (or the parameter dataset).

In 314, a simulated dataset may be generated by obtaining an initial state of each parameter vector in the autoencoder subspace model.

In 315, a multi-view depth image corresponding to an image of each sample fabric may be generated based on the simulated dataset. In some embodiments, operations 311-315 may also be referred to as a process for obtaining training data for training the deep neural network.

In 316, a trained deep neural network may be determined by training a deep neural network using the multi-view depth image.

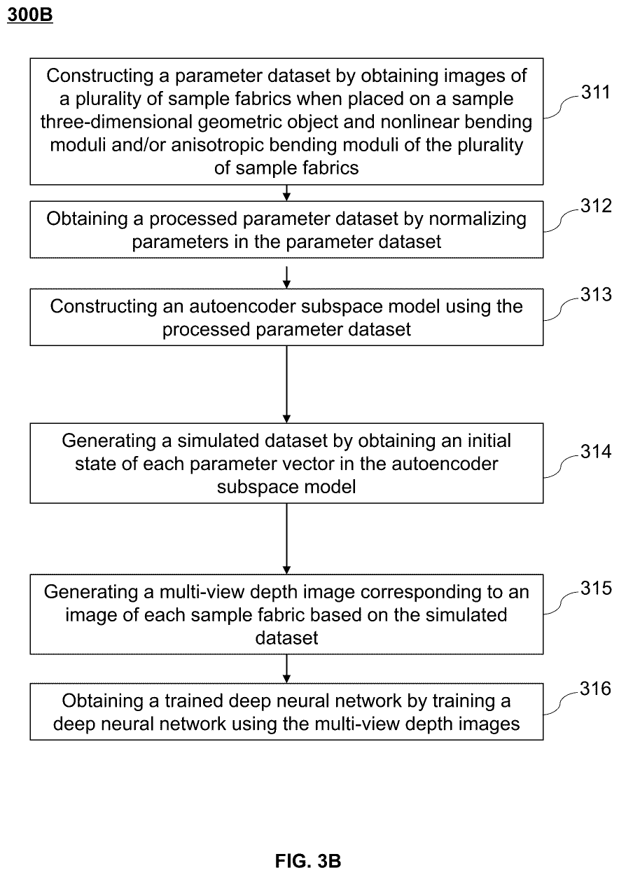

During the training of the deep neural network, in order to obtain a better multi-view depth image to improve the training accuracy, it is necessary to accurately simulate (or model) the state of the sample fabric. In order to better simulate a fabric (e.g., the sample fabric), the embodiments of the present disclosure provide a co-rotational finite element model configured to determine the planar stiffness of the fabric and a dihedral angle model configured to determine the bending stiffness of the fabric. If using the co-rotational finite element model to simulate the planar stiffness of a fabric, the planar stiffness may have an effect on the simulation of the bending performance of the fabric, resulting in a locking problem. Therefore, in order to solve this problem, the fabric is allowed to be freely stretched or compressed within a certain range (e.g., in a range of [98%, 102%], [99%, 101%], etc.). FIG. 4 is a schematic diagram illustrating a stretched state of a fabric according to some embodiments of the present disclosure. The stretched sample fabric is shown in FIG. 4.

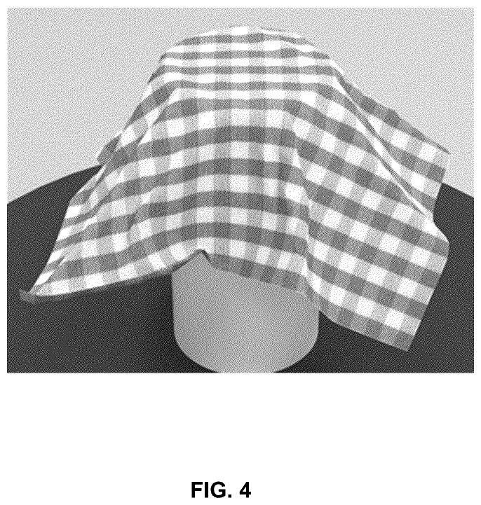

FIG. 5 is a schematic diagram illustrating bending along connected edges of a dihedral angle element in a dihedral angle model according to some embodiments of the present disclosure. A dihedral angle model is selected to determine the bending stiffness of the fabric while selecting bending moduli as parameters of the dihedral angle model. Specifically, it is assumed that a dihedral angle element of the dihedral angle model consists of two adjacent triangles. The two triangles can be on a same plane to form a reference state of the dihedral angle model. Assuming that the only way this dihedral angle element can deform is by bending along connected edges of the two triangles, as shown in FIG. 5. Thus, a bending energy of the dihedral angle element may be determined according to Equation (1):

$$E ( θ ) = {\int }_{0}^{θ} τ ( κ , e ) d θ , \qquad ( 1 )$$

where θ denotes a dihedral angle, κ denotes a curvature, e denotes a connection length of the connected edges of the two triangles, and τ(κ, e) denotes a torque with the curvature κ of the dihedral angle element and the connection length e being parameters.

Through the above Equation (1), a force on a vertex i may be calculated according to Equation (2) as follows:

$${f}_{i} = - {∇}_{i} E ( θ ) = - τ ( κ , e ) {∇}_{i} θ ( x ) , \qquad ( 2 )$$

where fᵢ denotes a force on the vertex i, a dihedral angle θ is considered as a function of a vertex position of the vertex, x denotes a vector of a position of the vertex i, and τ(κ, e) is assumed to have a linear proportional relationship with e.

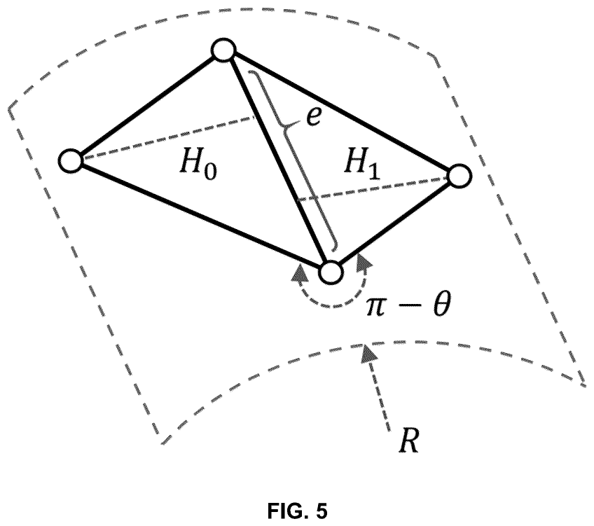

For the obtaining of the one or more nonlinear bending moduli and anisotropic bending moduli of a sample fabric, an image of the sample fabric (e.g., a fabric strip prepared using the sample fabric) on a cantilever tester (as shown in FIG. 6) may be obtained, the torque of any curve sample point in the curve sample point set may be obtained based on the curve sample point set on the image, and the nonlinear bending moduli and anisotropic bending moduli of the sample fabric may be determined based on the torque of any curve sample point.

Specifically, in order to simulate nonlinear bending properties (i.e., construct a nonlinear model) of the sample fabric to determine the nonlinear bending moduli of the sample fabric, the torque τ(κ, e) is defined as a quadratic function (i.e., Equation (3)) of the curvature κ:

$$τ ( κ , e ) = ( α κ + β {κ}^{2} ) e , \qquad ( 3 )$$

where e denotes a connection length of the connected edges of the two triangles, α and β denote two bending moduli of the sample fabric along a certain direction.

By defining α and β in the warp direction, the weft direction, and the oblique yarn direction, respectively, six parameters may be obtained, which constitute the bending moduli of the sample fabric. As used herein, the warp direction refers to a vertical direction of the sample fabric; the weft direction refers to the horizontal direction of the sample fabric; and the oblique yarn direction refers to the diagonal direction of warp and weft yarns or a direction that forms a certain angle with the edge of the sample fabric. Thus, the force on the vertex i may be determined as Equation (4) as follows:

$${f}_{i} = - ( α κ + β {κ}^{2} ) e {∇}_{i} θ ( x ) . \qquad ( 4 )$$

Assuming that the fabric deformation is almost isometric and that the dihedral angle element is small enough, θ≈0, and the dihedral angle element can be locally approximated by a cylinder with a radius of R, as shown in FIG. 5. In such cases, the curvature κ of the dihedral angle element may be estimated by the radius R of the cylinder, and the curvature κ may be determined based on Equation (5) as follows:

$$κ = \frac{1}{R} = \frac{2 sin θ}{{( {H}_{0}^{2} + {H}_{1}^{2} - 2 {H}_{0} {H}_{1} cos ( π - θ ) )}^{1 / 2}} \approx \frac{2 θ}{{H}_{0} + {H}_{1}} . \qquad ( 5 )$$

where H₀ and H₁ denote heights of the two triangles in the reference state. In this way, the curvature κ becomes a linear function of θ.

Generally, a fabric may exhibit different bending properties in different material orientations. A typical manner to simulate anisotropic bending of the fabric (i.e., construct an anisotropic model of the fabric) is to assign different coefficients of bending stiffness to the dihedral angle element based on an orientation of connected edges of the dihedral angle element in a material space. However, this manner does not actually simulate anisotropic bending correctly, because geometrically, the orientation of the connected edges of the dihedral angle element may not be consistent with the bending orientation. In simulation, such an error may result in the bending effect being dependent on the division of triangular meshes.

Thus, in this embodiment, curvatures of all vertexes of the dihedral angle element and directions of the curvatures may be calculated. An average of directions of the maximum curvatures of two edge vertexes may be determined as a bending direction of the dihedral angle element, which constitutes the anisotropic bending modulus of the fabric. Making k^{warp}=[α^{warp} β^{warp}] and k^{weft}=[α^{weft} β^{weft}] be bending moduli in the warp direction and the weft direction, respectively, the bending modulus k(φ) in any bending direction φ is similar to the curvature and may be approximated based on Equation (6) as follows:

$$k ( φ ) = {cos}^{2} φ {k}^{warp} + {sin}^{2} φ {k}^{weft} . \qquad ( 6 )$$

In order to make the anisotropic model more accurate, the bending moduli in more than one sampling direction may be used as parameters {k^{warp}, . . . , k^{weft}} of the model. Assuming that φ₀ and φ₁ are two sampling directions, the bending moduli may be calculated according to Equation (7) as follows:

$$k ( φ ) = {[ \begin{matrix}{cos}^{2} φ \\ {sin}^{2} φ\end{matrix} ] [ \begin{matrix}{cos}^{2} {φ}_{0} & {sin}^{2} {φ}_{0} \\ {cos}^{2} {φ}_{1} & {sin}^{2} {φ}_{1}\end{matrix} ]}^{- 1} [ \begin{matrix}{k}_{{φ}_{0}} \\ {k}_{{φ}_{1}}\end{matrix} ] , \qquad ( 7 )$$

where, φ₀≤φ≤φ₁. Intuitively, according to the above equation (7), bending moduli in the warp and weft directions may be first predicted and be used to calculate k(φ). Then three sampling directions such as 0, π/4, and π/2 may be selected, and the final parameter vectors may be defined as:

$$k = [ \begin{matrix}{k}^{warp} & {k}^{diag} & {k}^{weft}\end{matrix} ] . \qquad ( 8 )$$

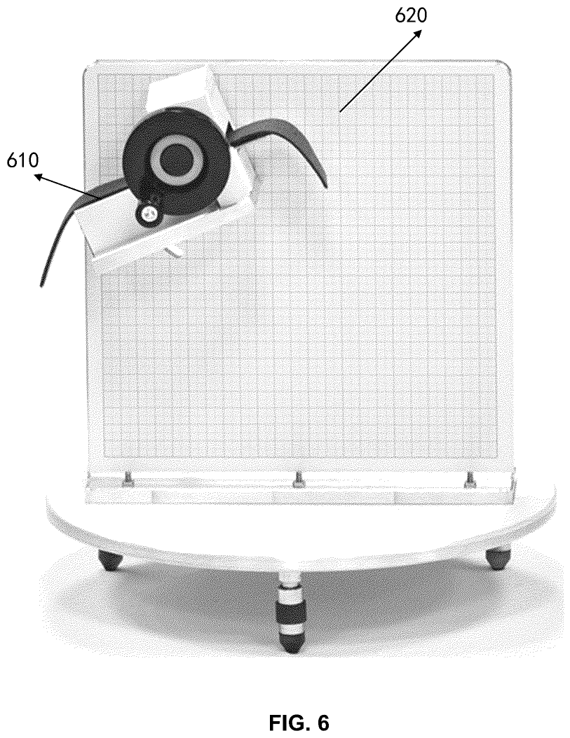

FIG. 6 is a schematic diagram illustrating an exemplary bending stiffness measurement device according to some embodiments of the present disclosure. FIG. 7 is a schematic diagram illustrating a bending curve of a fabric strip according to some embodiments of the present disclosure.

Specifically, in order to measure the sample fabric, a device (i.e., a bending stiffness measurement device) as shown in FIG. 6 is used. The device may include an adjustable beveled surface 610, a mesh substrate 620, and a telephoto DSLR camera (not shown) from a distance. A slope of the beveled surface 610 may be adjusted. For each sample fabric, a fabric strip of a certain size (e.g., 200 mm×30 mm) may be prepared in each of three material directions of the warp direction, the weft direction, and the oblique yarn direction, respectively. The fabric strip may be placed on the device shown in FIG. 6, and an image of the fabric strip may be obtained. Based on the image, a curve sample point set on the image may be obtained. Specifically, a bending curve of a fabric strip may be assumed as shown in FIG. 7. Further, by selecting multiple control points (such as 3 points, 4 points, 5 points, etc.) on the assumed curve and fitting them with a cubic Bessel curve, a function of the bending curve of the fabric strip may be determined. Then, the bending curve may be uniformly sampled along an X-axis (i.e., a horizontal direction of the mesh substrate 620) to obtain the curve sample point set. For example, the curve sample point set may include a set of curve sample points {r₀, . . . , r_{N}}, where N is an integer greater than 10 (e.g., 2000). Thus, a magnitude of a torque at point τᵢ may be determined according to Equation (9) as follows:

$${τ}_{i} = E ‖ {\int }_{{s}_{i}}^{{s}_{N}} ( r ( s ) - {r}_{i} ) \times df ( s ) ‖ = ρ gE {\int }_{{s}_{i}}^{{s}_{N}} ( x ( s ) - {x}_{i} ) ds . \qquad ( 9 )$$

where ρ denotes a fabric density, g denotes a gravitational acceleration of gravity, E denotes a width of the fabric strip, s denotes an arc length, and sᵢ and s_{N} denote arc lengths of a point τᵢ and a point r_{N}, respectively. x(s) denotes a projection of a corresponding position when the arc length is s on the X-axis. xᵢ denotes a projection of the i-th curve sample point on the X-axis. df(s) denotes a differential component of a force at the corresponding position when the arc length is s. Through sampling, the trapezoidal law may be applied to Equation (9) to calculate τᵢ:

$${τ}_{i} = ρ gE {\sum }_{j = i}^{N - 1} \frac{{x}_{j} + {x}_{j + 1} - 2 {x}_{i}}{2} ‖ {r}_{j + 1} - {r}_{j} ‖ . \qquad ( 10 )$$

At the same time, according to τ=(ακ+βκ²)e, where α and β denote two unknown bending moduli. For each point rᵢ, after κᵢ and τᵢ of the point τᵢ are estimated, α and β may be determined by solving a quadratic regression problem. Six bending moduli for a nonlinear anisotropic model of any fabric, respectively, may be obtained, i.e., bending moduli α and β corresponding to the warp direction, the weft direction, and the oblique yarn direction, respectively,

From the above descriptions, it can be seen that α and β are linearly related to the fabric density ρ in the cantilever test. In some embodiments, the measured bending moduli may be normalized. For example, assuming that all fabrics have the same density, for example, ρ̅=300 g·mm⁻², then the measured bending moduli are normalized to be α̅←αρ̅/ρ, β̅←βρ̅/ρ, where τ denotes a density of the sample fabric. When a normalized bending modulus is needed to revert back to an actual bending modulus, one just needs to multiply it by ρ/ρ̅.

Further, the normalized parameters (i.e., the normalized bending moduli) may be used to construct the autoencoder subspace model and train a deep neural network. In the embodiments of the present disclosure, an autoencoder subspace model (e.g., a variational autoencoder (VAE) subspace model) is utilized to define the subspace, which essentially attempts to take a parameter vector as an input and recover a same vector result at an output end. Merely by way of example, a VAE subspace model is taken as an example of the autoencoder subspace model in the present disclosure. Specifically, an encoder of the VAE subspace model consists of three fully connected layers with 2048, 1024, and 512 units, respectively. A size of a latent space is 64. A decoder of the VAE subspace model has an opposite structure to the encoder. An Adam optimizer is used to train the VAE subspace model with a decay weight of 10⁻⁵, a learning rate of 10⁻⁴, and a batch size of 16. A first count (e.g., 494) of parameter vectors is randomly selected as the training data and a second count (e.g., 50) of parameter vectors is used as the evaluation data. After the VAE subspace model is trained, random latent space vectors satisfying the Gaussian distribution N (0, 1) may be conveniently transferred into parameter vectors as parameter vector samples through the decoder.

Due to the limited training data and the limited measurement accuracy of the bending stiffness measurement device (e.g., a cantilever tester), the subspace may not be sufficient to cover all types of fabrics. In order to deal with this issue (or expand parameter vector space), instead of sampling the latent space variables via a Gaussian distribution N(0, 1), this implementation uses a Gaussian distribution N(μ, σ) to sample the parameters in the parameter dataset, covering the more types of fabrics, where μ∈ [−0.5, 0.5], and σ∈ [0.8, 1.2] are two uniformly distributed random variables, which can efficiently expand the transformed parameter vector space.

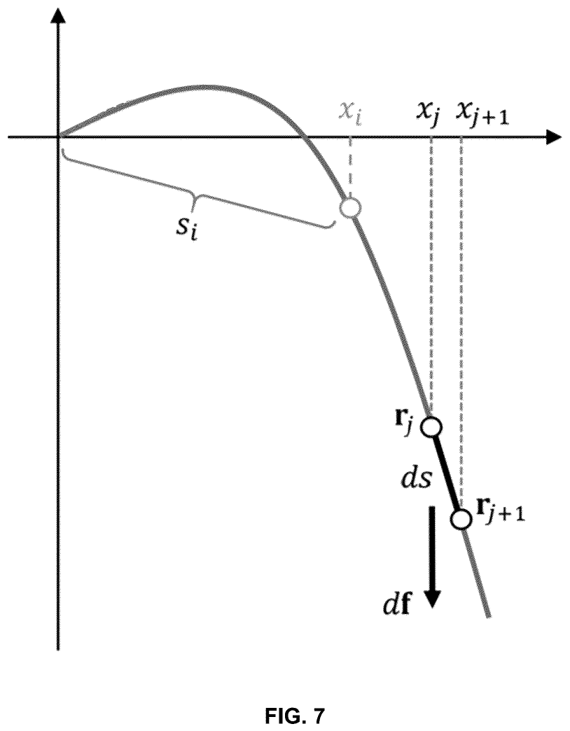

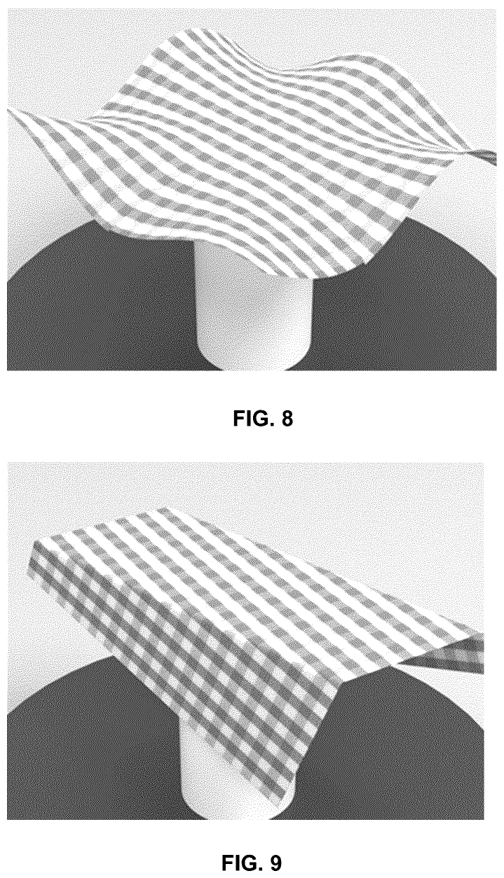

After defining the subspace, the fabric needs to be simulated (i.e., construct a simulation model). Due to the fact that the drape effect of a fabric is related to how a person comes into contact with the fabric, it is impossible to accurately and controllably to record the entire draping process. From a mathematical perspective, the simulated target has multiple local minima, each corresponding to a possible dangling result. FIG. 8 is a schematic diagram illustrating a state of a fabric formed by adding a random sine wave to meshes of the fabric when the fabric is in a flat state according to some embodiments of the present disclosure. FIG. 9 is a schematic diagram illustrating a state of a fabric formed by intentionally folding fabric meshes in a randomly selected direction according to some embodiments of the present disclosure. In the embodiments of the present disclosure, three types of initial states of the fabric are considered. The three types of initial states may include a state generated by adding a random sine wave to meshes of the fabric when the fabric is in a flat state (as shown in FIG. 8), a state formed by intentionally folding the fabric meshes in a randomly selected direction (as shown in FIG. 9), or a state determined by randomly selecting an initial state of other sample fabrics that have been well simulated in the simulated dataset, which is determined as an initial state of a current sample fabric.

For each parameter vector, multiple (e.g., eight) initial states are randomly generated. Since a center of the sample fabric may not exactly match a center of the three-dimensional geometric object (e.g., a cylinder), a small random perturbation may be added to a location of each initial state of the sample fabric (or each parameter vector). Then the sample fabric may be simulated to be static and balanced, e.g., using a simulation engine (e.g., the training device), to obtain an initial state parameter vector. Merely by way of example, a mesh resolution of the sample fabric is 100×100. Each simulation is typically completed in 20 seconds. After the simulation is completed, the simulation results (i.e., the initial state parameter vectors) and the corresponding parameter vectors may be added to the simulated dataset.

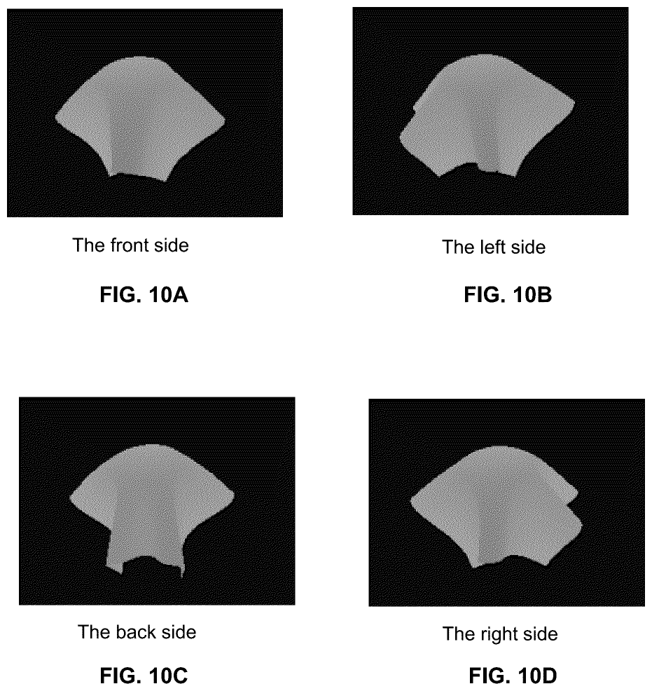

For each simulated data in the simulated dataset, at least one random orientation may be obtained by stratified random sampling. Using the at least one random orientation, at least one set of multi-view depth image may be synthesized by randomly perturbing the camera position, pose, or field of view. Merely by way of example, 12 random orientations of each simulation model may be obtained by performing the stratified sampling, which are then used, along with random perturbations to a camera position, pose, or field of view, to synthesize twelve sets of 240×180 multi-view depth images. FIG. 10A to FIG. 10D are diagrams illustrating exemplary depth images of the front side, the left side, the back side, and the right side, respectively, according to some embodiments of the present disclosure. For example, as shown in FIG. 10A to FIG. 10D, the multi-view depth image may include four views (i.e., the front side, the left side, the back side, and the right side). Subsequently, Kinect-related noise may be added to the synthetic multi-view depth image to obtain a real multi-view depth image similar to the one that contains noise and errors. Finally, each set of multi-view depth image and its corresponding parameter vector may be used as a data point in a depth image dataset.

Merely by way of example, 6,000 parameter vector samples are generated and 48,000 simulation models are simulated. The simulated models are then transformed into data points in the depth image dataset containing a total of 48,000×12×4=2.3M depth images. The depth images in the depth image dataset and the corresponding sample fabric images may be used to train the deep neural network, and during the training processing, the deep neural network may output the bending stiffness of the corresponding sample fabrics.

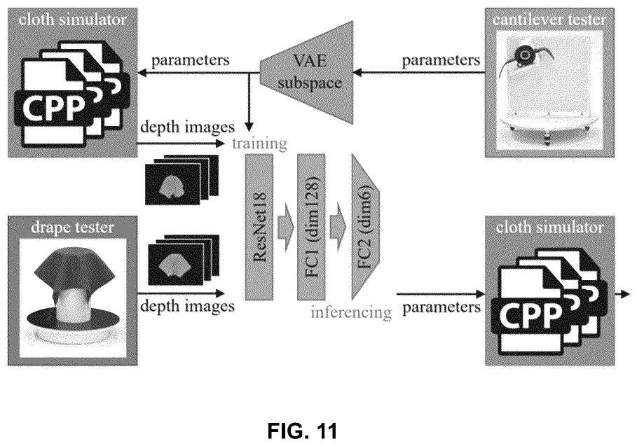

FIG. 11 is a schematic diagram illustrating an exemplary structure of a deep neural network according to some embodiments of the present disclosure. Merely by way of example, as shown in FIG. 11, the deep neural network described in this embodiment may include one ResNet-18 layer and two fully connected layers. The entire deep neural network contains 12.8M variables. The loss function of the deep neural network may be defined as a root mean square error (RMSE) between a ground truth {gᵢ} and an estimated result {pᵢ}:

$$L = {( \frac{{\sum }_{i = 1}^{N} {‖ {p}_{i} - {g}_{i} ‖}^{2}}{N} )}^{1 / 2} , \qquad ( 11 )$$

where N denotes a batch size. The Adam optimizer is used to train this deep neural network with a decay weight of 10⁻⁴, a learning rate of 10⁻⁴, and a batch size of 128, the learning rate decays to 0.995.

Specifically, a sample fabric image and its corresponding depth image may be simultaneously input into an input layer of the deep neural network. An intermediate layer of the deep neural network (such as ResNet-18 layer) may generate a predicted depth image based on the sample fabric image. The intermediate layer of the deep neural network may compare the generated predicted depth image with the input depth image. When the comparison result meets a preset condition (e.g., the value of the loss function is smaller than a threshold), the deep neural network may output the bending stiffness of the sample fabric. Otherwise, the parameters of the deep neural network may be adjusted to update the deep neural network and the updated deep neural network may be trained using other sample fabric images and their corresponding depth images.

After the deep neural network is trained, the trained deep neural network may be used to determine the bending stiffness of a fabric to be tested based on an image of the fabric to be tested when placed on a three-dimensional geometric object.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the VAE subspace model and the deep neural network may be integrated as a whole model. The input layer of the VAE subspace model may be served as the input layer of the whole model, and the output layer of the deep neural network may be served as the output layer of the whole model. In the whole model, the output layer of the VAE subspace model and the input layer of the deep neural network may be the same layer. That is to say, the generated normalized parameters (i.e., the normalized bending moduli) may be directly used as training samples to train the whole model. In practice, the image of a fabric to be tested placed on a three-dimensional geometric object may be directly input into the whole model, and the whole model may output the bending stiffness of the fabric to be tested.

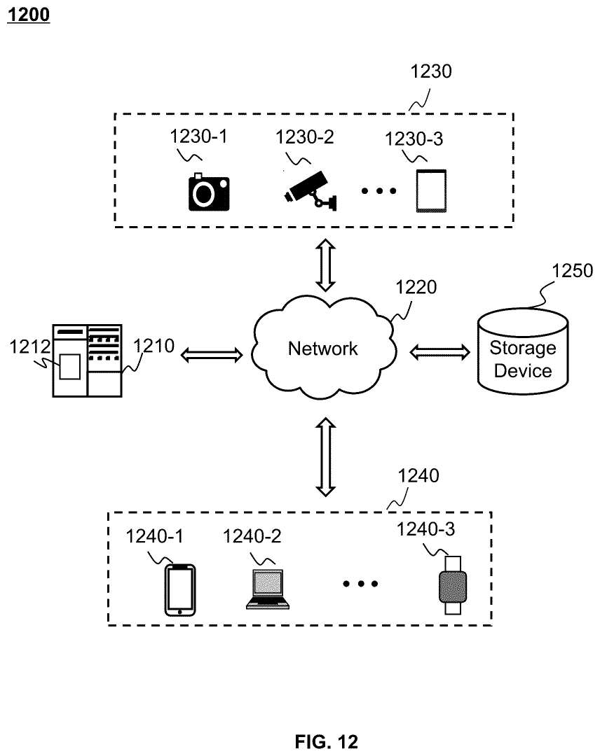

FIG. 12 is a schematic diagram illustrating an exemplary bending stiffness measurement system according to some embodiments of the present disclosure. As shown in FIG. 12, the stiffness measurement system 1200 may include a server 1210, a network 1220, an image acquisition device 1230, a terminal device 1240, and a storage device 1250.

The server 1210 may be a single server or a server group. The server group may be centralized or distributed (e.g., the server 1210 may be a distributed system). In some embodiments, the server 1210 may be local or remote. In some embodiments, the server 1210 may be implemented on a cloud platform. In some embodiments, the server 1210 may be implemented on a computing device 1300 having one or more components illustrated in FIG. 2 in the present disclosure.

In some embodiments, the server 1210 may include a processing device 1212. The processing device 1212 may process data and/or information relating to bending stiffness measurement to perform one or more functions described in the present disclosure. For example, the processing device 1212 may obtain an image of a fabric to be tested when placed on a three-dimensional geometric object. Further, the processing device 1212 may determine a bending stiffness of the fabric to be tested by inputting the image of the fabric to be tested into a trained deep neural network. In some embodiments, the processing device 1212 may include one or more processing engines (e.g., single-core processing engine(s) or multi-core processor(s)).

In some embodiment, the server 1210 may be unnecessary and all or part of the functions of the server 1210 may be implemented by other components (e.g., the image acquisition device 1230, the terminal device 1240) of the stiffness measurement system 1200. For example, the processing device 1212 may be integrated into the image acquisition device 1230 or the terminal device140 and the functions of the processing device 1212 may be implemented by the image acquisition device 1230 (e.g., an image signal processor (ISP) in the image acquisition device 1230) or the terminal device140.

The network 1220 may facilitate the exchange of information and/or data for the stiffness measurement system 1200. In some embodiments, one or more components (e.g., the server 1210, the image acquisition device 1230, the terminal device 1240, or the storage device 1250) of the stiffness measurement system 1200 may transmit information and/or data to one or more other components of the stiffness measurement system 1200 via the network 1220. For example, the server 1210 may obtain/acquire images from the image acquisition device 1230 via the network 1220. As another example, the image acquisition device 1230 may transmit images to the storage device 1250 for storage via the network 1220. In some embodiments, the network 1220 may be any type of wired or wireless network, or combination thereof.

The image acquisition device 1230 may be configured to acquire at least one image (the “image” herein refers to a single image or a frame of a video). In some embodiments, the image acquisition device 1230 may include a camera 1230-1, an image monitoring device 1230-2, a smartphone 1230-3, etc. In some embodiments, the image acquisition device 1230 may include a plurality of components each of which can acquire an image. For example, the image acquisition device 1230 may include a plurality of sub-cameras that can capture images or videos simultaneously. In some embodiments, the image acquisition device 1230 may transmit the acquired image (or captured frame) to one or more components (e.g., the server 1210, the terminal device 1240, and/or the storage device 1250) of the stiffness measurement system 1200 via the network 1220.

The terminal device 1240 may be configured to receive information and/or data from the server 1210, the image acquisition device 1230, and/or the storage device 1250 via the network 1220. For example, the terminal device 1240 may receive images and/or videos from the image acquisition device 1230. As another example, the terminal device 1240 may transmit instructions to the image acquisition device 1230 and/or the server 1210. In some embodiments, the terminal device 1240 may provide a user interface via which a user may view information and/or input data and/or instructions to the stiffness measurement system 1200. For example, the user may input, via the user interface, an instruction to set a shooting parameter of the image acquisition device 1230. In some embodiments, the terminal device 1240 may include a mobile device 1240-1, a computer 1240-2, a wearable device 1240-3, or the like, or any combination thereof. In some embodiments, the terminal device 1240 may include a display that can display information in a human-readable form, such as text, image, audio, video, graph, animation, or the like, or any combination thereof. In some embodiments, the terminal device 1240 may be connected to one or more components (e.g., the server 1210, the image acquisition device 1230, and/or the storage device 1250) of the stiffness measurement system 1200 via the network 1220.

The storage device 1250 may be configured to store data and/or instructions. The data and/or instructions may be obtained from, for example, the server 1210, the image acquisition device 1230, and/or any other component of the stiffness measurement system 1200. In some embodiments, the storage device 1250 may store data and/or instructions that the server 1210 may execute or use to perform exemplary methods described in the present disclosure. In some embodiments, the storage device 1250 may include a mass storage device, a removable storage device, a volatile read-and-write memory, a read-only memory (ROM), or the like, or any combination thereof. In some embodiments, the storage device 1250 may be implemented on a cloud platform.

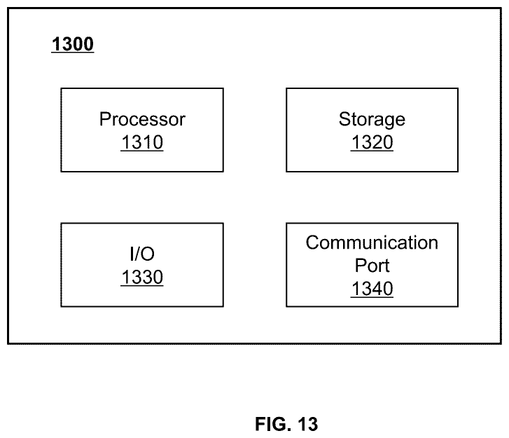

FIG. 13 is a schematic diagram illustrating exemplary hardware and/or software components of an exemplary computing device according to some embodiments of the present disclosure. As illustrated in FIG. 13, the computing device 1300 may include a processor 1310, a storage 1320, an input/output (I/O) 1330, and a communication port 1340.

The processor 1310 may execute computer instructions (program code) and perform functions of the processing device 1212 in accordance with techniques described herein. The computer instructions may include, for example, routines, programs, objects, components, signals, data structures, procedures, modules, and functions, which perform particular functions described herein. In some embodiments, the processor 1310 may perform instructions obtained from the terminal device 1240. In some embodiments, the processor 1310 may include one or more hardware processors.

Merely for illustration, only one processor is described in the computing device 1300. However, it should be noted that the computing device 1300 in the present disclosure may also include multiple processors. Thus, operations and/or method steps that are performed by one processor as described in the present disclosure may also be jointly or separately performed by the multiple processors. For example, if in the present disclosure the processor of the computing device 1300 executes both operation A and operation B, it should be understood that operation A and operation B may also be performed by two or more different processors jointly or separately in the computing device 1300 (e.g., a first processor executes operation A and a second processor executes operation B, or the first and second processors jointly execute operations A and B).

The storage 1320 may store data/information obtained from the image acquisition device 1230, the terminal device 1240, the storage device 1250, or any other component of the stiffness measurement system 1200. In some embodiments, the storage 1320 may include a mass storage device, a removable storage device, a volatile read-and-write memory, a read-only memory (ROM), or the like, or any combination thereof. In some embodiments, the storage 1320 may store one or more programs and/or instructions to perform exemplary methods described in the present disclosure. For example, the storage 1320 may store a program for the processing device 1212 for measuring bending stiffness of a fabric.

The I/O 1330 may input or output signals, data, and/or information. In some embodiments, the I/O 1330 may enable user interaction with the processing device 1212. In some embodiments, the I/O 1330 may include an input device and an output device.

The communication port 1340 may be connected with a network (e.g., the network 1220) to facilitate data communications. The communication port 1340 may establish connections between the processing device 1212, the image acquisition device 1230, the terminal device 1240, or the storage device 1250. In some embodiments, the connection may be a wired connection, a wireless connection, or a combination of both that enables data transmission and reception.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

In some embodiments, the present disclosure also provides a device for measuring bending stiffness of a fabric (also referred to as a bending stiffness measurement device), comprising: a storage medium and a processing unit. The storage medium is configured to store a computer program. The processing unit exchanges data with the storage medium. When measuring the bending stiffness of the fabric, operations of the method for measuring bending stiffness of a fabric as described above are implemented when the processing unit executes the computer program.

In the above-described device, the storage medium is preferably, a storage device such as a removable hard disk, a solid-state hard disk, a USB flash drive, etc. The processing unit is preferably a CPU to exchange data with the storage medium and implement operations of the method for measuring bending stiffness of a fabric when executing the computer program.

The above-mentioned CPU may perform various appropriate actions and operations in accordance with a program stored in the storage medium. The above-described device may further include following peripherals, including an input component such as a keyboard, a mouse, etc., and also an output component such as a cathode ray tube (CRT), a liquid crystal display (LCD), etc., as well as a loudspeaker, etc. In particular, according to embodiments disclosed in the present disclosure, the process depicted in FIG. 3 may be implemented as a computer software program.

In some embodiments, the present disclosure also provides a computer program product comprising a computer program carried on a computer-readable storage medium. The computer program includes program codes for implementing the method as set forth in FIG. 3. The computer program may be downloaded and installed from a network. When the computer program is executed by the CPU, functions defined in the system of the present disclosure can be performed.

In some embodiments, the present disclosure further provides a computer-readable storage medium. The computer-readable storage medium has a computer program stored therein. The computer program, when running, performs operations of the method for measuring bending stiffness of a fabric as described above. In the present disclosure, the computer-readable storage medium may be any tangible medium comprising or storing a program that can be used by or in combination with an instruction execution system, an apparatus, or a device.

In the present disclosure, a computer-readable signal medium may include a data signal propagated in a baseband or as part of a carrier, which carries computer-readable program codes. Such propagated data signal may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits data for use by, or in combination with, an instruction-executing system, a device, or an apparatus. The program codes carried on the computer-readable medium may be transmitted using any suitable medium including, but not limited to: wireless, wire, fiber optic cable, RF, or the like, or any suitable combination thereof.

The above descriptions are only a part of the embodiments of the present disclosure, which is not intended to limit the scope of protection of the present disclosure. Any equivalent device or equivalent process transformations utilizing the contents of the present disclosure and the accompanying drawings, or applying them directly or indirectly in other related technical fields, are similarly included in the scope of patent protection of the present disclosure.

What is claimed is:

1. A machine learning-based method for measuring bending stiffness of a fabric, comprising:
obtaining an image of a fabric to be tested placed on a three-dimensional geometric object; and
determining the bending stiffness of the fabric to be tested by inputting the image of the fabric to be tested into a trained deep neural network.

2. The method of claim 1, wherein the trained deep neural network is trained using training data, the training data being obtained by a process including:
obtaining sample images of a plurality of sample fabrics placed on a sample three-dimensional geometric object;
obtaining nonlinear bending moduli and/or anisotropic bending moduli of the plurality of sample fabric;
constructing a parameter dataset based on the nonlinear bending moduli and the anisotropic bending moduli of the plurality of sample fabrics;
constructing an autoencoder subspace model using the parameter dataset,
generating a simulated dataset by obtaining an initial state of each parameter vector in the autoencoder subspace model, and
generating a multi-view depth image corresponding to each sample image of each sample fabric based on the simulated dataset; and
determining multi-view depth images corresponding to the sample images of the plurality of sample fabrics as the training data.

3. The method of claim 2, wherein the obtaining the nonlinear bending moduli and the anisotropic bending moduli of the plurality of sample fabrics includes:
for each of the plurality of sample fabrics, preparing a fabric strip of the sample fabric;
obtaining an image of the fabric strip when the fabric strip is placed on a cantilever tester;
obtaining a curve sample point set based on the image of the fabric strip, the curve sample point set including multiple curve sample points;
determining a torque of each curve sample point in the curve sample point set; and
determining the nonlinear bending moduli and the anisotropic bending moduli of the sample fabric based on the torque of each curve sample point.

4. The method of claim 3, wherein the obtaining a curve sample point set based on the image of the fabric strip and determining a torque of each curve sample point in the curve sample point set includes:
fitting a bending curve of the fabric strip based on at least one control point selected from the image of the fabric strip,
determining the curve sample point set by sampling the bending curve of the fabric strip uniformly along an X-axis, the curve sample point set including curve sample points {r₀, . . . , r_{N}};
determining a magnitude of the torque at a curve sample point τᵢ according to following formula:
$${τ}_{i} = E ‖ {\int }_{{s}_{i}}^{{s}_{N}} ( r ( s ) - {r}_{i} ) \times df ( s ) ‖ = ρ gE {\int }_{{s}_{i}}^{{s}_{N}} ( x ( s ) - {x}_{i} ) d s ,$$
whereτᵢ denotes the magnitude of the torque at a curve sample point rᵢ, ρ denotes a density of the sample fabric, g denotes a gravitational acceleration, E denotes a width of the fabric strip, s denotes an arc length, and sᵢ and s_{N} denote arc lengths of the curve sample points rᵢ and r_{N}, respectively, df(s) denotes a differential component of a force at a corresponding position when the arc length is s, x(s) denotes a projection of the corresponding position when the arc length is s on the X-axis, and xᵢ denotes a projection of the i-th curve sample point on the X-axis.

5. The method of claim 3, wherein the determining the nonlinear bending moduli and the anisotropic bending moduli of the sample fabric based on the torque of each curve sample point includes:
determining six parameters that is obtained by defining two bending moduli of the sample fabric in a warp direction, a weft direction, and an oblique yarn direction, respectively, as the nonlinear bending moduli of the sample fabric;
calculating a curvature and a direction of the curvature on each vertex of each dihedral angle element formed based on the image of the sample fabric; and
determining the anisotropic bending moduli of the sample fabric by estimating an average of directions of maximum curvatures of two edge points of a connected edge of the dihedral angle element as a bending direction of the dihedral angle element.

6. The method of claim 2, wherein the constructing the autoencoder subspace model using the parameter dataset includes:
randomly selecting a portion of parameter vectors in the parameter dataset as a training set and the other portion of parameter vectors in the parameter dataset as an evaluation set;
training the autoencoder subspace model using an Adam optimizer to obtain a trained autoencoder subspace model; and
evaluating the trained autoencoder subspace model using the evaluation set.

7. The method of claim 6, wherein before constructing the autoencoder subspace model using the parameter dataset, the method further includes:
increasing the parameter vectors in the parameter dataset by:
using a Gaussian distribution N(μ, σ) to sample parameters in the parameter dataset, wherein μ∈ [−0.5, 0.5] and σ∈ [0.8, 1.2] and μ and σ are two uniformly distributed random variables.

8. The method of claim 2, wherein the generating a simulated dataset by obtaining an initial state of each parameter vector in the autoencoder subspace model includes:
for each parameter vector in the autoencoder subspace model, randomly generating multiple initial states of the sample fabric;
adding a random perturbation to a position of each initial state of the sample fabric;
obtaining an initial state parameter vector by simulating the random perturbation of the sample fabric until the sample fabric is static; and
adding the initial state parameter vector and the corresponding parameter vector into the simulated dataset.

9. The method of claim 8, wherein the initial state includes:
a state formed by adding a random sine wave to fabric meshes of the sample fabric in flat;
a state formed by intentionally folding fabric meshes of the sample fabrics in a randomly selected direction; or
a state determined by randomly selecting an initial state of a sample fabric that have been simulated in the simulated dataset.

10. The method of claim 2, wherein the generating a multi-view depth image corresponding to each sample image of each sample fabric based on the simulated dataset includes:
obtaining at least one random orientation of each simulated data in the simulated dataset by performing stratified random sampling; and
synthesizing at least one set of multi-view depth image by randomly perturbing, using the at least one random orientation, a position, pose, or field of view of a camera.

11. The method of claim 2, wherein the trained deep neural network is trained by:
defining a loss function of a deep neural network as a root mean square error L between a ground truth {gᵢ} and an estimated result {φᵢ}, wherein
$$L = {( \frac{{\sum }_{i = 1}^{N} {‖ {p}_{i} - {g}_{i} ‖}^{2}}{N} )}^{1 / 2}$$
where N denotes a batch size, and
training the deep neural network using an Adam optimizer to obtain the trained deep neural network.

12. A system, comprising:
at least one storage device storing executable instructions for measuring bending stiffness of a fabric; and
at least one processor in communication with the at least one storage device, wherein when executing the executable instructions, the at least one processor is configured to cause the system to perform operations including:
obtaining an image of a fabric to be tested placed on a three-dimensional geometric object; and
determining the bending stiffness of the fabric to be tested by inputting the image of the fabric to be tested into a trained deep neural network.

13. The system of claim 12, wherein the trained deep neural network is trained using training data, the training data being obtained by a process including:
obtaining sample images of a plurality of sample fabrics placed on a sample three-dimensional geometric object;
obtaining nonlinear bending moduli and anisotropic bending moduli of the plurality of sample fabric;
constructing a parameter dataset based on the nonlinear bending moduli and the anisotropic bending moduli of the plurality of sample fabrics;
constructing an autoencoder subspace model using the parameter dataset,
generating a simulated dataset by obtaining an initial state of each parameter vector in the autoencoder subspace model, and
generating a multi-view depth image corresponding to each sample image of each sample fabric based on the simulated dataset; and
determining multi-view depth images corresponding to the sample images of the plurality of sample fabrics as the training data.

14. The method of claim 13, wherein the obtaining the nonlinear bending moduli and the anisotropic bending moduli of the plurality of sample fabrics includes:
for each of the plurality of sample fabrics, preparing a fabric strip of the sample fabric;
obtaining an image of the fabric strip when the fabric strip is placed on a cantilever tester;
obtaining a curve sample point set based on the image of the fabric strip, the curve sample point set including multiple curve sample points;
determining a torque of each curve sample point in the curve sample point set; and
determining the nonlinear bending moduli and the anisotropic bending moduli of the sample fabric based on the torque of each curve sample point.

15. The system of claim 14, wherein the obtaining a curve sample point set based on the image of the fabric strip and determining a torque of each curve sample point in the curve sample point set includes:
fitting a bending curve of the fabric strip based on at least one control point selected from the image of the fabric strip,
determining the curve sample point set by sampling the bending curve of the fabric strip uniformly along an X-axis, the curve sample point set including curve sample points {r₀, . . . , r_{N}};
determining a magnitude of the torque at a curve sample point τᵢ according to following formula:
$${τ}_{i} = E ‖ {\int }_{{s}_{i}}^{{s}_{N}} ( r ( s ) - {r}_{i} ) \times df ( s ) ‖ = ρ gE {\int }_{{s}_{i}}^{{s}_{N}} ( x ( s ) - {x}_{i} ) d s ,$$
whereτᵢ denotes the magnitude of the torque at a curve sample point rᵢ, τ denotes a density of the sample fabric, g denotes a gravitational acceleration, E denotes a width of the fabric strip, s denotes an arc length, and sᵢ and s_{N} denote arc lengths of the curve sample points τᵢ and r_{N}, respectively, df(s) denotes a differential component of a force at a corresponding position when the arc length is s, x(s) denotes a projection of the corresponding position when the arc length is s on the X-axis, and xᵢ denotes a projection of the i-th curve sample point on the X-axis.

16. The method of claim 14, wherein the determining the nonlinear bending moduli and the anisotropic bending moduli of the sample fabric based on the torque of each curve sample point includes:
determining six parameters that is obtained by defining two bending moduli of the sample fabric in a warp direction, a weft direction, and an oblique yarn direction, respectively, as the nonlinear bending moduli of the sample fabric;
calculating a curvature and a direction of the curvature on each vertex of each dihedral angle element formed based on the image of the sample fabric; and
determining the anisotropic bending moduli of the sample fabric by estimating an average of directions of maximum curvatures of two edge points of a connected edge of the dihedral angle element as a bending direction of the dihedral angle element.

17. The method of claim 13, wherein the constructing the autoencoder subspace model using the parameter dataset includes:
randomly selecting a portion of parameter vectors in the parameter dataset as a training set and the other portion of parameter vectors in the parameter dataset as an evaluation set;
training the autoencoder subspace model using an Adam optimizer to obtain a trained autoencoder subspace model; and
evaluating the trained autoencoder subspace model using the evaluation set.

18. The method of claim 17, wherein before constructing the autoencoder subspace model using the parameter dataset, the method further includes:
increasing the parameter vectors in the parameter dataset by:
using a Gaussian distribution N(μ, σ) to sample parameters in the parameter dataset, wherein μ∈ [−0.5, 0.5] and σ ∈ [0.8, 1.2] and μ and σ are two uniformly distributed random variables.

19. The method of claim 13, wherein the generating a simulated dataset by obtaining an initial state of each parameter vector in the autoencoder subspace model includes:
for each parameter vector in the autoencoder subspace model, randomly generating multiple initial states of the sample fabric;
adding a random perturbation to a position of each initial state of the sample fabric;
obtaining an initial state parameter vector by simulating the random perturbation of the sample fabric until the sample fabric is static; and
adding the initial state parameter vector and the corresponding parameter vector into the simulated dataset.

20. A non-transitory computer readable medium, comprising at least one set of instructions for measuring bending stiffness of a fabric, wherein when executed by at least one processor of a computing device, the at least one set of instructions direct the at least one processor to perform operations including:
obtaining an image of a fabric to be tested placed on a three-dimensional geometric object; and
determining the bending stiffness of the fabric to be tested by inputting the image of the fabric to be tested into a trained deep neural network.
